(19) United States
(12) Patent Application Publication
(10) Pub. No.: US 2014/0361544 A1
(43) Pub. Date: Dec. 11, 2014

(54) WIND TURBINE TOWER ENCLOSURE

(71) Applicant: General Electric Company, Schenectady, NY (US)

(72) Inventors: James Eric Reed, Spartanburg, SC (US); James Christopher Butts, Brunswick, ME (US)

(21) Appl. No.: 13/911,376

(22) Filed: Jun. 6, 2013

(51) Int. Cl. F03D 9/00

(52) U.S. Cl. CPC F03D 9/002
USPC 290/55

(57) ABSTRACT

An enclosure associated with a wind turbine tower includes a plurality of pre-assembled sections configured to be attached to a section of the wind turbine tower. The plurality of pre-assembled sections form an enclosure around the section. The enclosure is configured for storage of electrical components associated with a wind turbine. The enclosure is also configured to increase available space within the wind turbine tower by storage of the electrical components in the enclosure.

### BACKGROUND OF THE INVENTION

The apparatus described herein relates generally to towers. More specifically, the apparatus relates to an improved tower for a wind turbine.

Modern wind turbine installations generally include a tower erected on a foundation at the site. The wind turbine blades are mounted to a rotor hub that, in turn, drives a shaft that is coupled via a gearbox to a generator. The gearbox, generator, shaft, and related equipment are contained within a nacelle that is supported atop the tower. The essential power production components, such as switch cabinets, power distribution panels, converter threads, main control cabinet, and the like, are typically placed in various arrangements on the foundation and the bottom section of the tower is erected around or placed over the power production components. This configuration and associated process have certain disadvantages.

For example, the process requires precise placement and arrangement of the components, typically by manual measurement and marking on the foundation, prior to placement of the tower section. A faulty measurement or placement can result in a time-consuming and costly relocation of the components. Servicing and maintenance of the power production components requires access and entry into the tower. The components are typically arranged in a three or four tiered assembly at the base of the tower, which must be climbed and navigated to access the various components. Space for performing service and maintenance procedures is quite limited. In addition, the component tiers must be climbed and navigated each and every time a technician must access the nacelle for any reason. The tiered arrangement of power production components within the tower also produce significant heat that traverses up the tower to the nacelle in a chimney-like effect, which can result in an increased load on the component cooling equipment within the nacelle.

FIG. 1 illustrates a wind turbine 10 of conventional construction. The wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The base section of the tower 12 is mounted on a foundation 20, which is typically a concrete foundation. An access door 22 permits access to the interior of the tower 12. A plurality of power production components 24 are located within the base section of the tower 12 in a tiered or stacked configuration. These essential power production components may include, for example, switch cabinets, power distribution panels, converter threads, control cabinets, and so forth. The tower 12 is typically erected in sections, with the base section being lowered onto the power production components 24 once they have been arranged in their tiered array. The disadvantages of this particular configuration are that the space available to the components is limited, the working space around the components is very limited and component removal or maintenance is difficult. It can also be appreciated from FIG. 1 that, access to the nacelle 14 via the tower requires that personnel traverse the multiple tiers of power production components 24. The presence of the components 24 also reduce the available space inside the tower to ladders or other lift devices.

### BRIEF DESCRIPTION OF THE INVENTION

In an aspect of the present invention, an enclosure associated with a wind turbine tower includes a plurality of pre-assembled sections configured to be attached to a section of the wind turbine tower. The plurality of pre-assembled sections form an enclosure around the section. The enclosure is configured for storage of electrical components associated with a wind turbine. The enclosure is also configured to increase available space within the wind turbine tower by storage of the electrical components in the enclosure.

In another aspect of the present invention, an enclosure associated with a wind turbine tower includes a plurality of pre-assembled sections configured to be attached to a bottom section of the wind turbine tower. The plurality of pre-assembled sections form a substantially annular shaped enclosure around the bottom section, and the annular shaped enclosure is configured for storage of electrical components associated with a wind turbine. The enclosure is connected to the wind turbine tower.

In yet another aspect of the present invention, a wind turbine tower includes an enclosure having a plurality of pre-assembled sections attached to a bottom section of the wind turbine tower. The plurality of pre-assembled sections form a substantially annular shaped enclosure around the bottom section. The annular shaped enclosure is configured for storage of electrical components associated with a wind turbine, and includes a plurality of removable panels configured to permit and facilitate access, installation and removal of the electrical components. The annular shaped enclosure is configured to increase available space within the wind turbine tower by storage of the electrical components in the annular shaped enclosure.

### BRIEF DESCRIPTION OF THE DRAWINGS

FIG. 1 illustrates a perspective view of a conventional wind turbine;

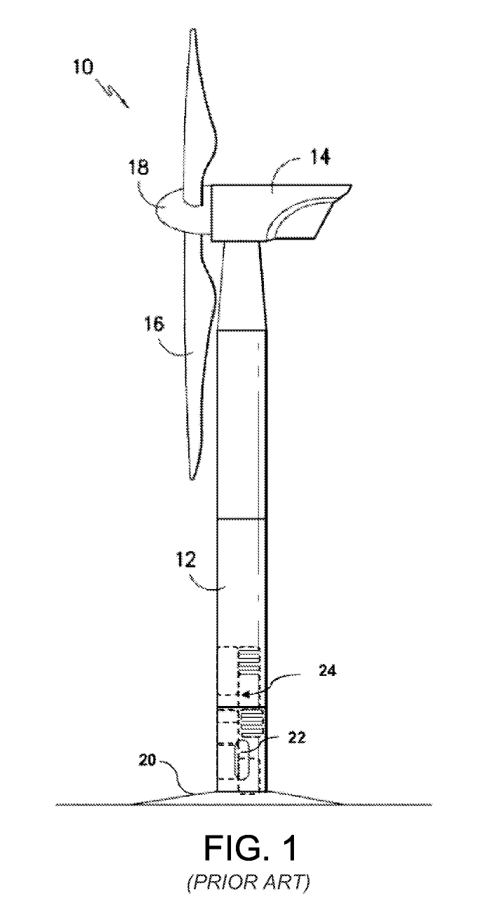

FIG. 2 illustrates a schematic view of a wind turbine, according to an aspect of the present invention;

FIG. 3 illustrates a top, cross-sectional view of the enclosure, according to an aspect of the present invention;

FIG. 4 illustrates a perspective view of the enclosure, according to an aspect of the present invention; and

FIG. 5 illustrates a cross-sectional view of one of the filtered vents, according to an aspect of the present invention.

### DETAILED DESCRIPTION OF THE INVENTION

One or more specific aspects/embodiments of the present invention will be described below. In an effort to provide a concise description of these aspects/embodiments, all features of an actual implementation may not be described in the specification. It should be appreciated that in the development of any such actual implementation, as in any engineering or design project, numerous implementation-specific decisions must be made to achieve the developers' specific goals, such as compliance with machine-related, system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “one aspect” or “an embodiment” or “an aspect” of the present invention are not intended to be interpreted as excluding the existence of additional embodiments or aspects that also incorporate the recited features.

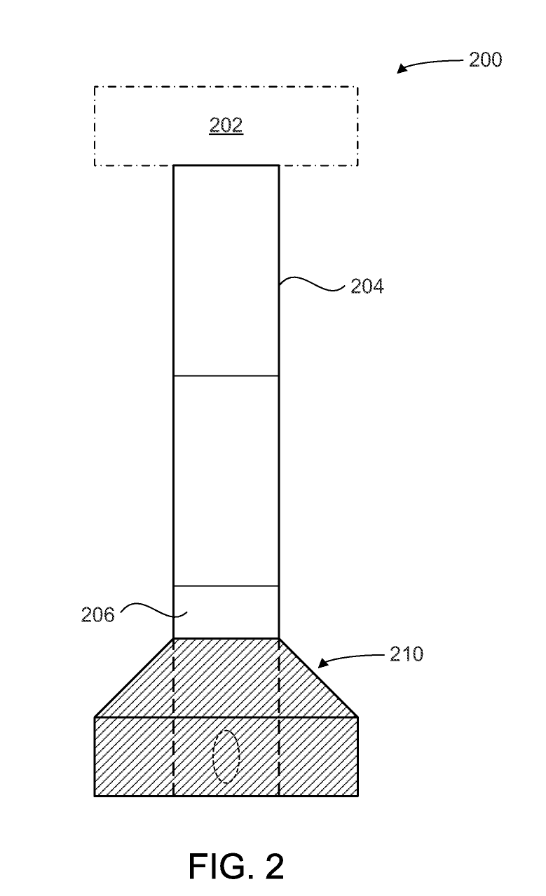

FIG. 2 illustrates a schematic view of wind turbine 200, according to an aspect of the present invention. The wind turbine 200 includes a nacelle 202. A rotor (not shown) is typically attached to the nacelle (or mainframe housed within the nacelle). The nacelle is mounted to a tower 204 having one or more sections. A bottom section 206 of the tower rests on the foundation (not shown). An annular shaped enclosure 210 is located around a portion of the bottom section 206 and increases the amount of space for the storage of electrical components or other equipment associated with wind turbine 200. The term bottom section is understood to include any portion of a tower located near the bottom thereof. However, the enclosure may be attached to other portions of the tower, including the upper or middle sections, or any other section as desired in the specific application.

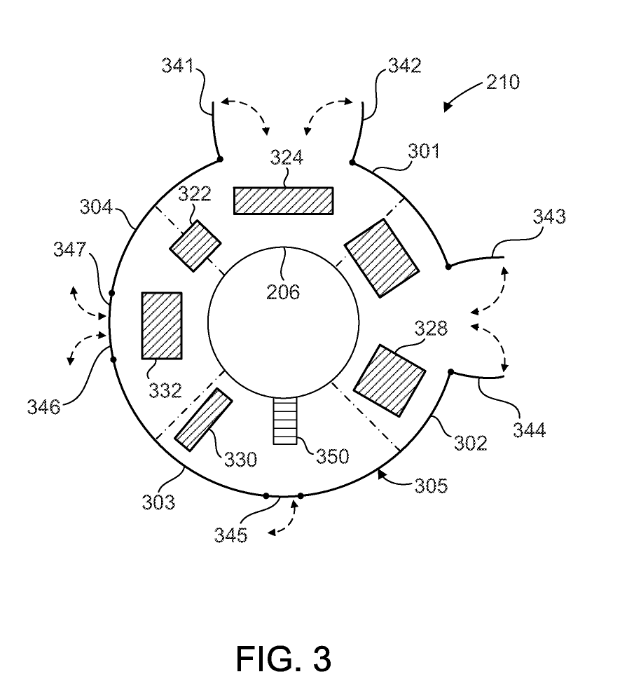

FIG. 3 illustrates a top, cross-sectional view of the enclosure, according to an aspect of the present invention. The enclosure 210 includes a plurality of pre-assembled sections 301, 302, 303, 304 configured to be attached to the bottom section 206 of the wind turbine tower 204. The plurality of pre-assembled sections 301, 302, 303, 304 form a substantially annular shaped enclosure 305 around the bottom section 206. A portion of a wall of the wind turbine tower completes the enclosure 210, for example, part of the wall 206 may form an inner portion of the enclosure 210. The annular shaped enclosure 305 is configured for storage of electrical components and other equipment associated with the wind turbine 200. The annular shaped enclosure 305 is configured to increase available space within the wind turbine tower 204 by storage of the electrical components in the annular shaped enclosure instead of within the bottom section 206. However, it is to be understood that the enclosure 210 may be formed in other shapes beside annular, for example, rectangular, polygonal, circular or any other suitable shape. The enclosure 210 may also comprise one or more levels for access or storage purposes.

The electrical components may include a pump 322, transformer 324, converter 326, battery storage 328, cooling equipment 330, control panels 332 or other equipment. Many of these components generate substantial amounts of heat and the confined space available inside bottom section 206 made cooling of these components difficult. In addition, the prior approach of stacking components in multiple levels exacerbated the cooling problem and limited access space around the components. It could be difficult to access various locations to service and repair components when they were housed within the bottom section 206. The annular shaped enclosure 305 is proportioned to provide the desired safety clearances and access clearances around the electrical components. For example, the diameter of the annular shaped enclosure may be between about 9-15 meters. This size would provide excellent airflow and access around each component and facilitate installation and removal of the components. Any diameter could be chosen, as long as it was larger than the diameter of the bottom section 206. Another advantage is that the enclosure 210 can appear to be a part of the tower structure. The amount of extra room (or footprint) that is required is reduced compared to non-annular enclosures, and this can be very beneficial when the turbine is situated in agricultural fields or in populated locations where space is at a premium.

The annular shaped enclosure 305 also includes a plurality of removable panels or doors 341-347 configured to permit and facilitate access, installation and removal of the electrical components 322, 324, 326, 328, 330, 332. The term “removable” is defined as being capable of being removed or opened, for example, the doors 341-347 can be opened and closed by pivoting on one or more hinges (not shown). The doors 341-347 may also slide open and closed, or may be removed from the enclosure. In FIG. 3 panels 341 and 342 are shown in the opened condition, and it can be seen that access to the transformer 324 is greatly facilitated. The transformer 324 can now be easily installed or removed from its location, and the access clearances around the transformer are vastly improved over its location in bottom section 206. For example, a forklift can easily be maneuvered into and out of the doors 341, 342. Panels 343 and 344 are also shown in the opened condition, and provide excellent access to the converter 326 and battery storage 328. The batteries 328 may be used to power turbine components or they may be used for energy storage to supply power to the electrical grid during transients or periods of intermittent or low wind. The batteries 328 may include an array of sodium-nickel batteries or any other type of battery or fuel cell capable of storing the desired amount of power for the specific application. Many batteries generate heat during charging or use, and the improved clearances and airflow around the batteries greatly improves their performance. Panel or door 345 is shown in the closed condition, and may be used as a general personal access door for the enclosure 210, to access tower stairs 350 or the cooling equipment 330. Doors 346 and 347 are also shown in the closed condition and provide access to the control panels 332. The arrangement of the specific components is merely one example, and it is to be understood that the components could be arranged in any desired location and configuration, and that other equipment could be included as well. Furthermore, the removable panels 341-347 are sized so that substantial disassembly of the electrical components 322, 324, 326, 328, 330, 332 is not required for installation or removal of the electrical components into or out of the annular shaped enclosure 305.

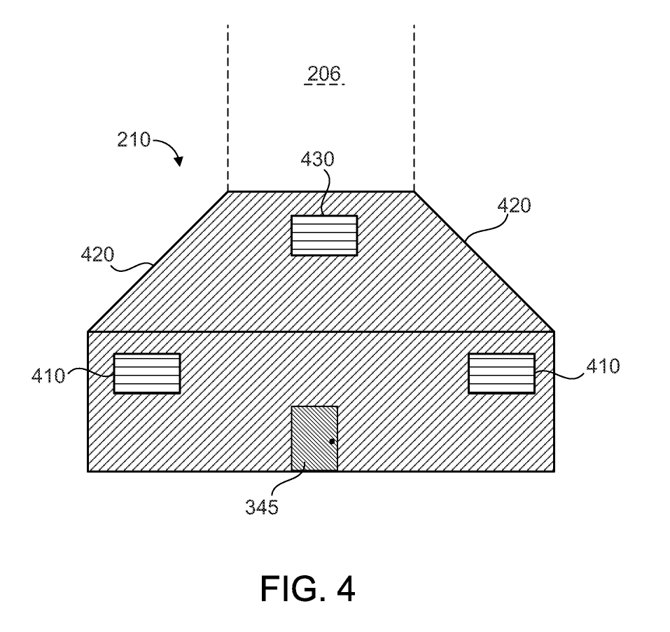

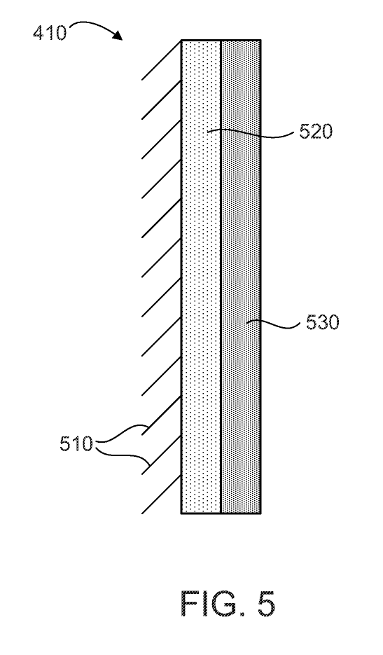

FIG. 4 illustrates a perspective view of the enclosure 210, according to an aspect of the present invention. The enclosure 210 may include a plurality of filtered vents 410 configured to provide ventilation for the electrical components 322, 324, 326, 328, 330, 332. FIG. 5 illustrates a cross-sectional view of one of the filtered vents 410 and each vent may include a plurality of louvers 510, a particulate filter 520 and/or an acoustic filter 530. The louvers 510 limit the ingress of rain or water. The particulate filter 520 filters out particulate matter such as dust, dirt or other contaminants that are undesired within enclosure 210 or around the electrical components 322, 324, 326, 328, 330, 332. The acoustic filter 530 is designed to reduce the amount of noise exiting the enclosure 210, and this may be desired in populated environments or where the wind turbine 200 is close to residences.

The enclosure 210 also includes an inclined roof 420 attached to the bottom section 206 of the wind turbine tower 204. The inclined roof 420 may also include a plurality of exhaust vents 430 (only one of which is shown) configured to exhaust heat generated from the electrical components.

The enclosure, according to aspects of the present invention provides a number of advantages and benefits. Electrical components are housed outside the main tower structure in a more accessible enclosure. The working space around the electrical components is safer, because of increased clearances, and better due to increased cooling airflow. The enclosure 210 demonstrates substantially improved results that were unexpected, because the electrical component life can be increased due to the improved cooling provided by the enclosure environment. In addition, the main tower structure can be opened up to provide more room for maintenance crew to ascend and descend the tower. It will now be possible to include mechanical/electrical lift devices to assist the maintenance crew in moving personnel and equipment up and down the tower. Finally, the foundational footprint of the tower and enclosure is kept within desired tolerances, so the wind turbine can be located in land-use sensitive locations.

The enclosure 210 may also be configured to have less volume than the main tower 204, 206. For example, the internal volume of the enclosure 210 may be about 30% to about 80% less than the internal volume of main tower 204, 206. The lower volume of the enclosure 210 permits lower volumes of air to be cooled and enhances component cooling (and efficiency) compared to known towers where the electrical components were stored inside the main tower in a multi-tiered configuration.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An enclosure associated with a wind turbine tower, the enclosure comprising:
a plurality of pre-assembled sections configured to be attached to a section of the wind turbine tower; the plurality of pre-assembled sections forming a substantially annular shaped enclosure around the section; the enclosure configured for storage of electrical components associated with a wind turbine, wherein the electrical components include any combination of a power converter, a transformer, battery storage, a pump, or cooling equipment; and
wherein, the enclosure is configured to increase available space within the wind turbine tower by storage of the electrical components in the enclosure.

2. The enclosure of claim 1, wherein a portion of a wall of the wind turbine tower completes the enclosure.

3. The enclosure of claim 1, the enclosure further comprising:
a plurality of removable panels configured to permit and facilitate access, installation and removal of the electrical components.

4. The enclosure of claim 3, wherein the plurality of removable panels are sized so that substantial disassembly of the electrical components is not required for installation or removal of the electrical components into or out of the enclosure.

5. The enclosure of claim 1, the enclosure further comprising:
a plurality of filtered vents configured to provide ventilation for the electrical components, the plurality of filtered vents comprising at least one of particulate filters and acoustic filters.

6. The enclosure of claim 1, the enclosure further comprising:
an inclined roof attached to the bottom section of the wind turbine tower; and
wherein the inclined roof includes a plurality of exhaust vents configured to exhaust heat generated from the electrical components.

7. (canceled)

8. An enclosure associated with a wind turbine tower, the enclosure comprising:
a plurality of pre-assembled sections configured to be attached to a bottom section of the wind turbine tower; the plurality of pre-assembled sections forming a substantially annular shaped enclosure around the bottom section; the annular shaped enclosure configured for storage of electrical components associated with a wind turbine, wherein the electrical components include any combination of a power converter, a transformer, battery storage, a pump, or cooling equipment; and
wherein the enclosure is connected to the wind turbine tower.

9. The enclosure of claim 8, the annular shaped enclosure further comprising:
a plurality of panels configured to permit and facilitate access, installation and removal of the electrical components.

10. The enclosure of claim 9, wherein a portion of a wall of the wind turbine tower completes the enclosure.

11. The enclosure of claim 10, the annular shaped enclosure further comprising:
a plurality of filtered vents configured to provide ventilation for the electrical components, the plurality of filtered vents comprising at least one of particulate filters and acoustic filters.

12. The enclosure of claim 11, wherein the inclined roof includes a plurality of exhaust vents configured to exhaust heat generated from the electrical components.

13. The enclosure of claim 12, wherein the electrical components include any combination of power converter, transformer, battery storage, pump, cooling equipment, or control panel.

14. The enclosure of claim 13, wherein the annular shaped enclosure includes an inclined roof attached to the wind turbine tower.

15. A wind turbine tower comprising:
an enclosure having a plurality of pre-assembled sections attached to a bottom section of the wind turbine tower; the plurality of pre-assembled sections forming a substantially annular shaped enclosure around the bottom section; the annular shaped enclosure configured for storage of electrical components associated with a wind turbine, wherein the electrical components include any combination of a power converter, a transformer, battery storage, a pump, or cooling equipment; the annular shaped enclosure including a plurality of removable panels configured to permit and facilitate access, installation and removal of the electrical components; and
wherein, the annular shaped enclosure is configured to increase available space within the wind turbine tower by storage of the electrical components in the annular shaped enclosure.

16. The wind turbine tower of claim 15, the annular shaped enclosure further comprising:
an inclined roof attached to the bottom section of the wind turbine tower.

17. The wind turbine tower of claim 16, wherein the annular shaped enclosure includes a plurality of exhaust vents configured to exhaust heat generated from the electrical components.

18. The wind turbine tower of claim 17, the annular shaped enclosure further comprising:
a plurality of filtered vents configured to provide ventilation for the electrical components, the plurality of filtered vents comprising at least one of particulate filters and acoustic filters.

19. The wind turbine tower of claim 18, wherein the plurality of removable panels are sized so that substantial disassembly of the electrical components is not required for installation or removal of the electrical components into or out of the annular shaped enclosure.

20. The wind turbine tower of claim 19, wherein a portion of a wall of the wind turbine tower completes the enclosure.
